(19) United States
(12) Patent Application Publication
(10) Pub. No.: US 2026/0055571 A1
(43) Pub. Date: Feb. 26, 2026

(54) MANHOLE COVER, MANHOLE COVERING AND MONITORING SYTEM

(71) Applicant: ACO AHLMANN SE & CO. KG, Büdelsdorf (DE)

(72) Inventor: Alfred FUCHS, Hahnstätten (DE)

(21) Appl. No.: 19/103,956

(22) PCT Filed: Sep. 1, 2023
(86) PCT No.: PCT/EP2023/074060

§ 371 Date: Feb. 14, 2025

(30) Foreign Application Priority Data
Sep. 6, 2022 (DE) 10 2022 122 587.9

(51) Int. Cl. E02D 29/14; G08C 17/02

(52) U.S. Cl. CPC E02D 29/1427; G08C 17/02

(57) ABSTRACT

The invention relates to a manhole cover (10) for a manhole covering (50) comprising at least one locking device (20) for locking the manhole cover (10) to a shaft frame (40) of the manhole covering (50), wherein the locking device (20) has a latch (21) which is movable between an unlocking position (I) and a locking position (II), and a monitoring device (30) for monitoring the locking, wherein the latch (21) is movable from the locking position (II) into a pressing position (III) in order to press the manhole cover (10) firmly against the shaft frame (40) during use, wherein the monitoring device (30) is designed to detect the unlocking position (I), the locking position (II), and the pressing position (III) of the latch (21).

The invention relates to a manhole cover for a manhole covering according to the preamble of claim 1. Furthermore, the invention relates to a manhole covering having such a manhole cover and a monitoring system with such a manhole covering. A manhole cover of the type mentioned at the outset is known, for example, from EP 1 867 791 B1.

Manhole covers which are inserted into a shaft frame are generally used to cover underground shafts. When used on race tracks, such as Formula 1 race tracks, such manhole covers are exposed to extraordinary stresses. Due to the special design and the high driving speeds of racing cars, a negative pressure is generated between the racing car underbody and the race track, which can suction in the manhole cover in such a way that the manhole cover is lifted from the shaft frame and thrown upwards, for example onto an opposing racing car. This can result in serious accidents, which are often linked to a high health risk to drivers.

For this reason, such manhole covers are usually secured to the shaft frame by welding, screwing, or locking before the race. These safeguards are checked manually by service personnel in a separate step. However, manually checking each individual safeguard is error-prone and time-consuming. It has also been found that the high stresses can cause weld seams to break and mechanical safeguards to come loose on their own, for example as a result of vibrations when driving over them.

A manhole cover having a latch and a monitoring device is known from EP 1 867 791 B1. In the locked position, the latch engages with a shaft frame and thus prevents the manhole cover from being lifted. The monitoring device monitors the latch and communicates the locking status to a monitoring center. In this way, the service personnel in the monitoring center are directly informed about an unsecured manhole cover, so that immediate intervention is possible. However, until the service personnel actually intervene, the unsecured manhole cover poses a great danger to the racing cars and, in particular, to the racing drivers.

It is therefore the object of the present invention to improve a manhole cover of the type mentioned at the outset in such a way that safety is increased. The invention is also based on the object of providing a manhole covering having such a manhole cover and a monitoring system having such a manhole covering.

According to the invention, this object is achieved by a manhole cover according to claim 1 as well as a manhole covering according to claim 11 and a monitoring system according to claim 13.

Specifically, the object is achieved according to the invention by a manhole cover for a manhole covering. The manhole cover comprises at least one locking device for locking the manhole cover on a shaft frame of the manhole covering, wherein the locking device has a latch which is movable between an unlocking position and a locking position. The manhole cover also comprises a monitoring device to monitor the locking mechanism. The manhole cover is characterized in that the latch is movable from the locking position into a pressing position in order to press the manhole cover firmly against the shaft frame during use, wherein the monitoring device is designed to detect the unlocking position, the locking position, and the pressing position of the latch.

The invention is therefore based on the idea of providing a manhole cover which is not only lockable by means of the latch, but is also pressable firmly against the shaft frame. For this purpose, the latch is designed to be movable between the unlocking position, the locking position, and the pressing position, wherein the latch moves from the locking position to the pressing position by being pressed against the shaft frame.

By firmly pressing the latch in the pressing position against the shaft frame, the pressing force between the latch and the shaft frame as well as between the manhole cover and the shaft frame is increased. The risk that the latch will move into the unlocked area on its own against this pressing force is thus reduced. The pressing force also reduces the freedom of movement of manhole cover, shaft frame, and latch relative to one another, so that the risk of the latch unlocking on its own, for example as a result of vibrations when it is driven over, is further reduced. In addition, the distance that the latch has to overcome to reach the unlocked area is extended by the pressing position, so that the level of security is further increased.

The invention is based on the further concept that the monitoring device for monitoring the locking detects the pressing position, the locking position, and the unlocking position of the latch. During use, the monitoring device thus automatically detects whether the latch presses the manhole cover firmly against the shaft frame, merely locks the manhole cover to the shaft frame, or does not secure it at all. This allows the monitoring device to communicate the position of the latch, and thus the security status of the manhole cover, to a monitoring center in order to inform service personnel, for example.

The monitoring device thus detects a transition of the latch from the pressing position to the locking position, so that intervention can take place before the latch moves from the locking position into the unlocked area. This further reduces the risk of the lock unlocking itself.

A manhole cover according to the invention is designed for use with a shaft frame in manhole coverings on race tracks, for example Formula 1 race tracks. The manhole cover can also be used in other manhole coverings. It is also possible to use the inventive concept without a shaft frame and generally in connection with the covering of shafts or the like.

Preferred embodiments of the invention are provided in the dependent claims.

In a preferred embodiment of the invention, the locking device has at least one screw actuatable from the outside of the manhole cover, which in use moves the latch between the locking position and the pressing position. The screw allows the latch and thus the manhole cover to be pressed particularly firmly against the shaft frame, for example by means of an appropriate tool. The form fit and the self-locking of the screw thread hold the latch in the pressing position and additionally counteract independent unlocking of the lock. Since the screw is actuatable from the outside of the manhole cover, the latch can be moved between the locking position and the pressing position particularly easily and quickly, for example by service personnel by means of an appropriate tool.

The screw is preferably adapted to move, in particular to pivot, the latch between the unlocking position and the locking position. Since the screw thus simultaneously causes the movement of the latch between the unlocking position and the locking position, additional means for transmitting a movement to the latch are no longer required. This simplifies the structure of the manhole cover and reduces the effort required by service personnel, as the tool for actuating the screw only has to be applied once. To further simplify the structure, the latch is designed to be pivotable between the unlocking position and the locking position so that the rotational movement of the screw is transmittable directly to the latch.

Preferably, the locking device has a stop, in particular an angle stop, in each case for the latch in the unlocking position and in the locking position. The stops ensure that the latch exactly assumes the unlocking position and the locking position. Errors in detecting the positions of the latch by the monitoring device are thus reduced, so that the level of safety is increased. Particularly preferably, the stop for the latch in the locking position simultaneously also forms a stop for the latch in the pressing position in order to also ensure exact positioning of the latch in the pressing position.

In order to increase the pressing force between the manhole cover and the shaft frame, it is advantageous if the manhole cover has at least two, preferably three, locking devices.

In order to improve the pressing force between the manhole cover and the shaft frame, the locking devices are preferably arranged distributed, in particular evenly distributed, in the circumferential direction of the manhole cover. In this way, the pressing force acts distributed over the circumference, so that the manhole cover is pressed firmly against the shaft frame on all sides.

In order to detect the position of the latch particularly reliably, it is advantageous if the monitoring device has at least one sensor, in particular an inductive sensor, preferably a Hall sensor, for detecting the position of the latch. An inductive sensor measures the position change of the latch and therefore also detects positions of the latch between the unlocking position, the locking position, and the pressing position during use. The reliability of the detection of the latch position can be further increased in this way.

Preferably, the monitoring device has an antenna, in particular a ceramic antenna, in order to wirelessly transmit the information about the position of the latch to a monitoring center. This eliminates the need for communication lines, which are complex to install and maintain. However, since the antenna can be installed and removed quickly and easily, it reduces the effort required for installation and maintenance. The probability of errors during these work steps is also reduced.

It is advantageous if the monitoring device has at least one energy storage device for the autonomous energy supply. Since the energy storage device makes power lines obsolete, the effort required for installation and maintenance can be further reduced in this way. In addition, the energy storage device can be installed only when needed and then removed again, whereas power lines are permanently exposed to environmental influences. This advantageously reduces the risk of failure of the power supply.

In a preferred embodiment of the invention, the monitoring device is arranged in a protected housing on an inner side of the manhole cover. The housing protects the monitoring device from environmental influences and thus reduces the risk of failure.

Another independent aspect of the invention relates to a manhole covering having an above-described manhole cover and a shaft frame for receiving the manhole cover, wherein the manhole cover rests on a support surface of the shaft frame.

Thus, both the combination of manhole cover and shaft frame, as well as the manhole cover as such, i.e. independently of the shaft frame, are disclosed and claimed. For the effect and advantages of the manhole covering, reference is made to the statements in connection with the manhole cover. The refinements of the manhole cover explained above are therefore also disclosed in connection with the manhole covering.

In a preferred embodiment of the manhole covering, the latch of the locking device engages behind the shaft frame in the locking position, in particular a projection of the shaft frame, and presses against the shaft frame, in particular the projection of the shaft frame, in the pressing position, so that the manhole cover is pressed firmly against the support surface of the shaft frame.

Another independent aspect of the invention relates to a monitoring system having at least one manhole covering as described above and a monitoring center. The monitoring center is designed to receive information about the position of the latch from the monitoring device and to visualize the position of the latch.

For the effect and advantages of the monitoring system, reference is made to the statements in connection with the manhole cover and the manhole covering.

The invention is explained in greater detail hereinafter on the basis of exemplary embodiments with reference to the accompanying schematic drawings. In the figures:

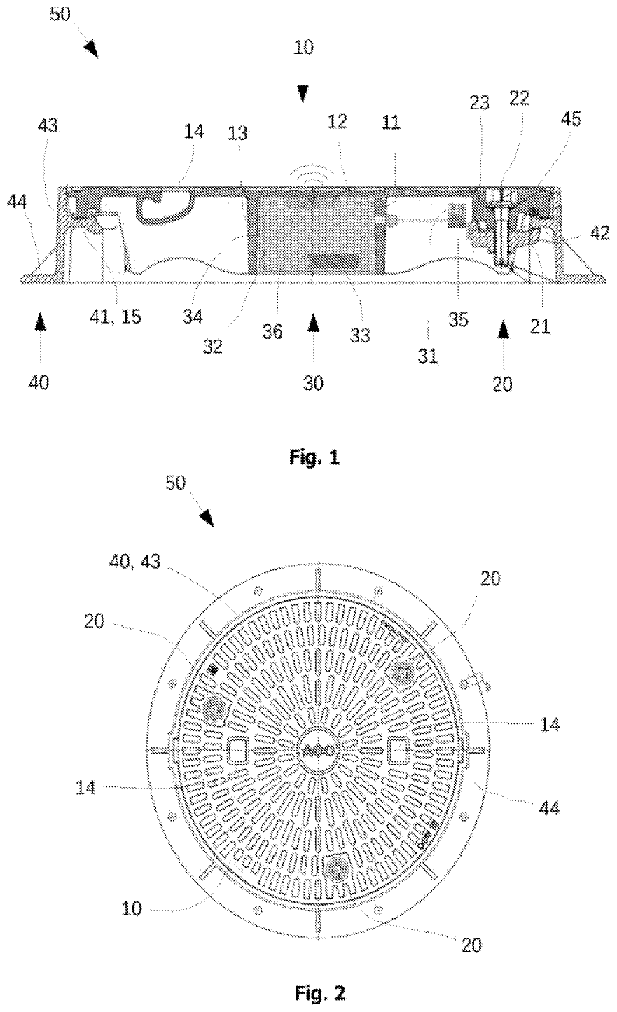

FIG. 1 shows a cross section of a manhole covering having a manhole cover according to an exemplary embodiment of the invention;

FIG. 2 shows a top view of the manhole covering from FIG. 1;

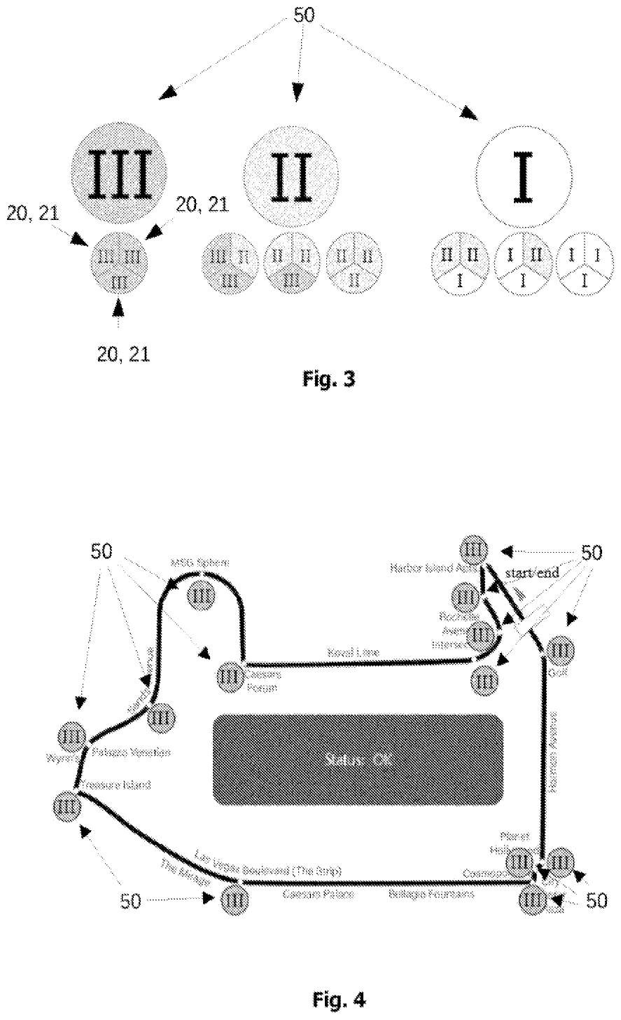

FIG. 3 shows a visualization of locking positions and securing states of a manhole covering provided by a monitoring system according to an exemplary embodiment of the invention;

FIG. 4 shows a visualization of secured manhole coverings on a race track provided by a monitoring system according to an exemplary embodiment of the invention;

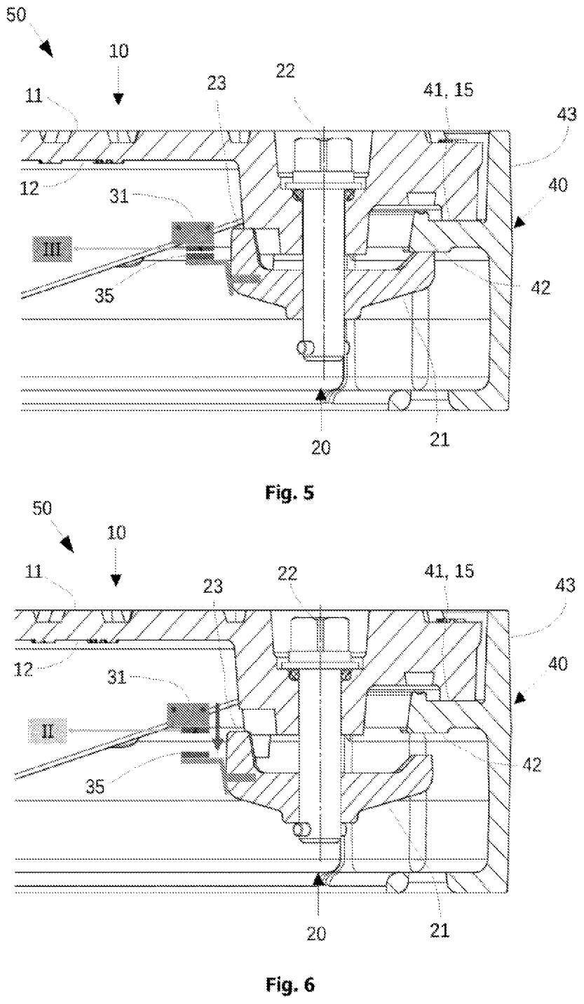

FIG. 5 shows a detailed view of a locking device of the manhole covering from FIG. 1, wherein a latch of the manhole covering is in the pressing position;

FIG. 6 shows a detailed view of a locking device of the manhole covering from FIG. 1, wherein the latch of the manhole covering is in the locking position;

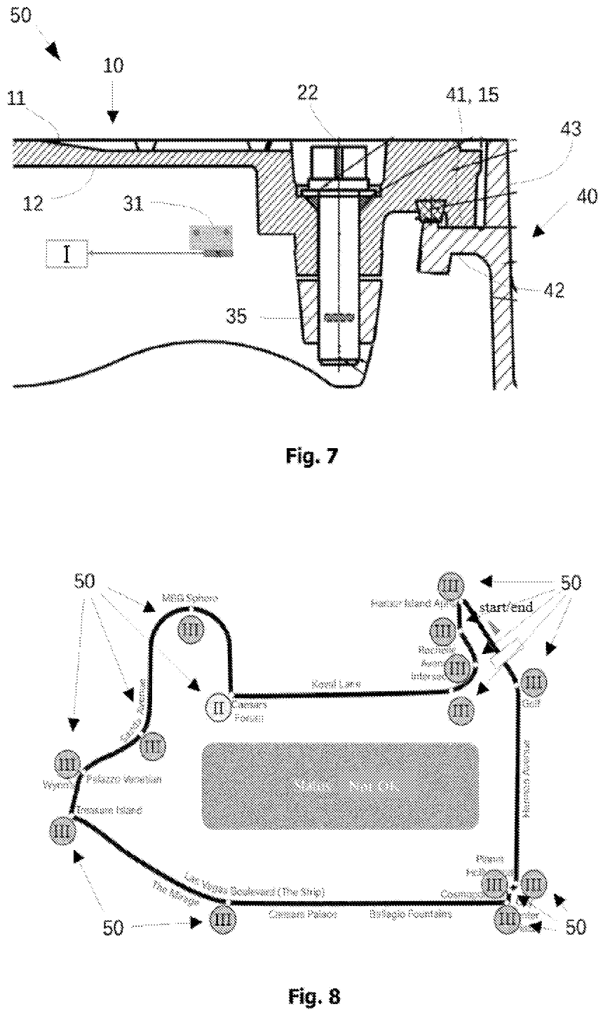

FIG. 7 shows a detailed view of a locking device of the manhole covering from FIG. 1, wherein the latch of the manhole covering is in the unlocking position; and

FIG. 8 shows the visualization from FIG. 4, wherein a manhole covering is unsecured.

The accompanying figures show a preferred exemplary embodiment of a manhole cover 10 for a manhole covering 50 on race tracks, specifically Formula 1 race tracks. However, the invention can also be used for other purposes.

Specifically, FIGS. 1 and 2 as well as 5 to 7 show a manhole covering 50 having the manhole cover 10 and a shaft frame 40, wherein the manhole cover 10 rests on a support surface 41 of the shaft frame 40. The manhole cover 10 comprises a monitoring device 30 and three locking devices 20 evenly distributed around the circumference. The manhole cover 10 can also comprise multiple monitoring devices 30 as well as only one locking device 20 or two or more than three locking devices 30.

In FIG. 1, a cross section of the manhole covering 50 through one of the three locking devices 20 is shown. Each locking device 20 has a latch 21.

To lock the manhole cover 10 to the shaft frame 40 and to release this locking, the latch 21 is movable between an unlocking position I and a locking position II. In order to press the manhole cover 10 firmly against the shaft frame 40 during use, the latch 21 is movable from the locking position II into a pressing position III.

FIG. 1 shows the latch 21 in pressing position III. The latch 21 forms an integral assembly with the manhole cover 10, wherein the latch 21 is arranged on an inner side 12 of the manhole cover 10. In locking position II and in pressing position III, the shaft frame 40 is arranged between the manhole cover 10 and the latch 21. The latch 21 therefore engages behind the shaft frame 40 both in locking position II and in pressing position III.

In pressing position III, the latch 21 presses against the shaft frame 40. Since the latch 21 and the manhole cover 10 form an integral assembly, the manhole cover 10 is itself pressed firmly against the shaft frame 40, specifically against the support surface 41 of the shaft frame 40, by the pressing force of the latch 21 in pressing position III.

In order to monitor the locking during use, for example during a race, the monitoring device 30 is designed to detect the unlocking position I, the locking position II, and the pressing position III of the latch 21. The monitoring device 30 thus monitors the locking during use by automatically detecting the position of the latch 21 and communicating this to a monitoring center. Since a transition of the latch 21 from the pressing position III to the locking position II is detected and communicated, intervention, for example by service personnel, is possible even before the latch 21 moves from the locking position III into the dangerous, unlocked area.

The locking device 20 has a screw 22 which is actuatable from an outer side 11 of the manhole cover 10. The screw 22 is inserted from the outer side 11 through a passage opening in the manhole cover 10 and protrudes with its screw thread on the inner side 12 of the manhole cover 10 from the passage opening. The latch 21 is screwed onto the protruding section of the screw 22. For this purpose, the latch 21 has a passage opening having an internal thread which forms a form fit with the screw thread.

In use, the screw 22 moves the latch 21 between the locking position II and the pressing position III. For this purpose, the screw 22 is actuated from the outer side 11 by means of a suitable tool. In this way, the latch 21 can be pressed firmly against the shaft frame 40 by tightening the screw 22, i.e. moved from the locking position II into the pressing position III. In order to move the latch 21 from the pressing position III back to the locking position II, the screw connection between screw 22 and latch 21 is loosened again.

The screw 22 is adapted to move, in particular to pivot, the latch 21 between the unlocking position I and the locking position II. Specifically, when the screw 22 is actuated, the latch 21 is rotated with the screw 22 between the unlocking position I and the locking position II due to the form fit between the latch 21 and the screw 22.

The latch 21 thus forms a sash lock or screw sash lock which is pivotable between the unlocking position I and the locking position II and is movable by screws between the locking position II and the pressing position III.

The locking device 20 has a stop, in particular an angle stop, in each case for the latch 21 in the unlocking position I and in the locking position II. The stops are arranged offset to one another at an angle of approximately 90° relative to the axis of the screw 22. The stop for the latch 21 in locking position II simultaneously also forms a stop for the latch 21 in pressing position III. The latch 21 has a projection 23 which is designed to interact with the stops in a force-transmitting manner in unlocking position I, locking position II, and pressing position III.

The stops thus limit the pivoting movement of the latch 21 between unlocking position I and locking position II. If the screw 22 is actuated or turned so that the latch 21 is pivoted from the unlocking position I in the direction of the locking position II, the latch 21 hits the respective stop in the locking position II so that it exactly assumes the locking position II. Since a continuation of the pivoting movement of the latch 21 in this direction is prevented by the stop, further rotation of the screw 22 screws the latch 21 in the direction of the manhole cover 10 into the pressing position III. The movement of the latch 21 from the pressing position III via the locking position II to the unlocking position I occurs analogously.

The monitoring device 30 has a sensor 31, specifically an inductive sensor, for example a Hall sensor. The sensor 31 is configured to detect a magnet 35 and to recognize its position or location. For this purpose, the sensor 31 is arranged on the inner side 12 of the manhole cover 10 in such a way that its position relative to the manhole cover 10 does not change when the latch 21 is adjusted or moved. The magnet, however, is arranged on the latch 21, so that when the latch 21 moves, the magnet 35 is moved along with it.

During use, the sensor 31 measures the change in the inductance or its quality due to a change in position relative to the magnet 35. During use, the latch 21, and thus the magnet 35, always assumes the same position relative to the sensor 31 in unlocking position I, locking position II, and pressing position III. The measurement result is therefore known in advance in the latch positions I, II, III, so that detection of these latch positions I, II, III is possible. Based on the same principle, the sensor 31 also detects positions of the latch 21 during use between the previously known latch positions I, II, III.

Other sensors can be used as long as the unlocking position I, the locking position II, and the pressing position III are detected.

The monitoring device 30 has an antenna 32, specifically a ceramic antenna 32. The antenna 32 is arranged centrally on the inner side 12 of the manhole cover 10 such that the distance to the outer side 11 of the manhole cover 10 is minimal. The use of other antennas and their arrangements is possible.

During use, the signal from the sensor 31, i.e. the information about the position of the latch 21, is transmitted wirelessly to the monitoring center by means of the antenna 32. The small distance to the outer side 11 reduces the shielding effect of the manhole cover 10, so that the signal transmission from the antenna 32 through the manhole cover 10 to the monitoring center is stabilized. Signal transmission by means of lines, for example communication lines, is also possible.

The signal of the sensor 31 is processed for signal transmission by an electronics unit 36 of the monitoring device 30. Specifically, the electronics unit 36 converts the signal from the sensor 31 into an NB-IoT (Narrowband Internet of Things) signal so that, for example, the racing car radio is not interfered with by the signal transmission.

The monitoring device 30 has an energy storage device 33 for autonomous energy supply, wherein the energy storage device 33 in the embodiment shown forms an electrical energy storage device, specifically an accumulator. Other energy storage devices, such as batteries, are possible. The energy storage device 33 is arranged in a waterproof compartment of the monitoring device 30.

During use, the energy storage device 33 autonomously supplies all electrical components of the manhole cover 10 with electrical energy. For this purpose, the energy storage device is installed in a full or fully charged state when required, for example before a race, and then removed again to be recharged for the next use. In this way, a reliable energy supply of all electrical components, in particular system-relevant ones, is ensured during use, for example during a race. In addition, this allows regular and simple maintenance of the energy storage device 33 before each use, thereby reducing the risk of failure during use.

The monitoring device 30 is arranged in a protected housing 34 on the inner side 12 of the manhole cover 10. For this purpose, the manhole cover 10 has a housing receiving means 13 which is designed protruding from the inner side 12 of the manhole cover 12 in the shape of a nozzle and is arranged centrally in relation to the manhole cover 10. The cylindrical housing 34 of the monitoring device 30 is arranged in the housing receiving means 13. The housing 34 forms a protected receiving space for the components of the monitoring device 30, wherein it encloses the antenna 32, the electronics unit 34, and the energy storage device 33.

In order to lift the manhole cover 10 from the shaft frame 40 in the unlocked state and to place it on the shaft frame 40, two tool receiving means 14 for corresponding tools, for example hooks, are provided on the outer side 11 of the manhole cover 10.

The screws 22 of the locking devices 20 each have a screw head which is arranged in a recess of the manhole cover 10 and ends essentially flush with the outer side 11 of the manhole cover 10. The screw heads of the screws 22 are thus arranged countersunk in the manhole cover 10 so that the outer side 11 is as flat as possible in order not to impair driving over, for example by racing cars.

The manhole cover 10 has a substantially circular outer contour, which is delimited on the inner side 12 by a circumferential, substantially circular ring-shaped support surface 15 of the manhole cover 10. The manhole cover 10 rests with its support surface 15 on the support surface 41 of the shaft frame 40.

The shaft frame 40 has a laterally circumferential frame wall 43. The frame wall 43 forms a nozzle which is closed on a side facing away from the shaft by the manhole cover 10. On a side facing toward the shaft, the frame wall 43 merges into a circular frame base 44 extending radially outward.

The shaft frame 40 has a projection 42. The projection 42 is formed circumferentially on the inside of the circumferential frame wall 43. The projection 42 thus extends radially inward from the frame wall 42, wherein it has a substantially circular ring-shaped geometry. On a side of the projection 42 facing away from the shaft, the support surface 41 is arranged, on which the manhole cover 10 rests. The latch 21 of the locking devices 20 engages behind the projection 42 of the shaft frame 40 in the locking position II and in the pressing position III, so that the projection 42 of the shaft frame 40 is arranged between the latch 21 and the manhole cover 10.

In the pressing position III, in this way the latch 21 presses against the projection 42 so that the manhole cover 10 is pressed firmly against the support surface 41 of the shaft frame 40. The projection 42 is thus compressed by the latch 21 and the manhole cover 40. The pressing force is adjustable by the screw 22.

Between the manhole cover 10 and the shaft frame 40, specifically the projection 42 of the shaft frame 40, a sealing means 45 is arranged, which is formed circumferentially along the projection 42. The sealing means 45 can also be designed differently. A manhole covering 50 without sealing means between manhole cover 10 and shaft frame 40 is also possible.

FIG. 2 shows a top view of the manhole covering 50 from FIG. 1. The essentially circular manhole cover 10 is arranged in the shaft frame 40, wherein the circular shaft bottom 44 surrounding the frame wall 43 is clearly visible in the top view. The three locking devices 20 evenly distributed around the circumference can be seen. The two oppositely arranged tool receiving means 14 are also clearly visible.

The functionality of a monitoring system according to an exemplary embodiment of the invention is explained hereinafter for a race track, specifically the Formula 1 race track in Las Vegas. The monitoring system comprises multiple, specifically 14, previously described manhole coverings 50 and a monitoring center. The monitoring center is designed to receive information about the position of the latch 21 from the monitoring device 30 and to visualize the position of the latch 21.

FIG. 3 shows such a visualization of the latch positions provided by the monitoring system. The three latches 21 of the manhole covering 50 can each be arranged in unlocking position I, in locking position II, or in pressing position III. A total of 27 different combinations of the three latch positions I, II, III are possible, seven of which are shown in FIG. 3 (indicated by seven pie diagrams).

Each combination of the three latch positions I, II, III forms a securing state of the manhole covering 50 or the manhole cover 10, wherein the manhole covering 50 is in an unlocking state I, a locking state II, or a pressing state III (indicated by three circles above the pie diagrams). The manhole covering 50 is in the unlocking state I when at least one of the three latches 21 is in the unlocking position I. If none of the three latches 21 is in the unlocking position I and at least one of the three latches 21 is in the locking position II, the manhole covering 50 is in the locking state II. Only when all three latches 21 are in pressing position III is the manhole covering 50 in the pressing state III and thus secured. Otherwise the manhole covering 50 is unsecured.

FIG. 4 shows a visualization of the security states of the manhole coverings 50 on the race track provided by the monitoring system. Since all manhole coverings 50 are in the pressing state III, i.e. secured, the race track is released for use, for example for a race (indicated by the status “OK”). In this case, all latches 21 are in pressing position III.

In FIG. 5, a detailed view of the locking device 20 of the manhole covering 50 from FIG. 1, the latch 21 is shown in pressing position III. Since the latch 21 engages behind the projection 42 of the shaft frame 40 and is simultaneously pulled by the screw 22 in the direction of the manhole cover 10, the latch 21 presses against the projection 42 of the shaft frame 40 so that the manhole cover 10 is pressed firmly against the support surface 41 of the shaft frame 40. The latch 21 is seated with its projection 23 in a cube-shaped depression on the manhole cover 10.

By pressing the latch 21 against the projection 42 of the shaft frame 40, the magnet 35 is held directly under the sensor. The distance between magnet 35 and sensor 31 is therefore minimal, so that it can be clearly assigned to the pressing position III of the latch 21. By detecting this previously known, clear distance, the pressing position III of the latch 21 is recognized.

Due to loosening of the screw connection between screw 22 and latch 21, for example as a result of vibrations when a racing car drives over the manhole covering 50 or as a result of actuating the screw 22 by means of an appropriate tool, the latch 21 is moved from the pressing position III into the locking position II. Since the latch 21 continues to be seated with its projection 23 in the cube-shaped recess on the manhole cover 10, a pivoting movement of the latch 21 around the axis of the screw 22 is prevented.

FIG. 6 shows the latch 21 from FIG. 1 in locking position II. It can be clearly seen that the latch 21 in locking position II continues to engage behind the projection 42 of the shaft frame 40, so that the manhole cover 10 remains locked to the shaft frame 40. However, in locking position II, the latch 21 does not press against the projection 42 of the shaft frame 40, but rests essentially loosely on the projection 42.

Due to the movement of the latch 21 from the pressing position III to the locking position II (indicated by the downward-pointing arrow), the distance between the magnet 35 and the sensor 31 is increased in comparison to the pressing position III. Since this increased distance can also be clearly assigned to the locking position II of the latch 21 due to the design, the detection of this distance makes it possible to recognize the locking position II of the latch 21.

If the latch 21 is moved from the locking position II to the unlocking position I due to further loosening of the screw connection between screw 22 and latch 21, the latch 21 lifts off the projection 42 of the shaft frame 40. The latch 23 is moved away from the manhole cover 10 to such an extent that the projection of the latch 23 comes loose completely from the cube-shaped depression on the manhole cover 10. Since the cube-shaped depression on the manhole cover 10 no longer counteracts a pivoting movement of the latch 21, the latch 21 is pivoted around the axis of the screw 22 until it hits the stop for the latch 21 in unlocking position I.

The latch 21 in unlocking position I is shown in FIG. 7. Since the latch 21 no longer engages behind the projection 42 of the shaft frame 40, the locking device 30, i.e. the locking function of the manhole cover 10 or the manhole covering 50, is unlocked.

The distance between magnet 35 and sensor 31 is further increased by the pivoting movement of the latch 21 from the locking position II to the unlocking position I in comparison to the locking position II. Since the magnet 35 is only arranged at such a distance from the sensor 31 in the unlocking position I due to its design, the unlocking position I of the latch 21 can be recognized by detecting this distance.

FIG. 8 shows the visualization from FIG. 4, where a manhole covering 50 is in the locking state II, i.e. unsecured. The remaining manhole coverings 50 are in the pressing state III equivalently to the visualization in FIG. 4 and are thus secured.

Since, in comparison to FIG. 4, not all manhole coverings 50 are in pressing state III or secured, the race track is not released for use, for example for a race (indicated by the status “Not OK”). In this way, the monitoring center informs the responsible service personnel, who can intervene immediately, for example by interrupting a race. The monitoring center can send out an alarm for this purpose.

Since the unsecured manhole covering 50 is in the locking state II, i.e. all three latches 21 in locking position II engage behind the shaft frame 40, lifting of the manhole cover 10 from the shaft frame 40 is prevented. The informed service personnel can thus intervene before one of the three latches 21 moves from the locking position III into the dangerous, unlocked area and enables the manhole cover 10 to be lifted.

### REFERENCE SIGNS

10 manhole cover
11 outer side
12 inner side
13 housing receiving means
14 tool receiving means
15 support surface of the manhole cover
20 locking device
21 latch
22 screw
23 projection of the latch
30 monitoring device
31 sensor
32 antenna
33 energy storage device
34 housing
35 magnet
36 electronics unit
40 shaft frame
41 support surface of the shaft frame
42 projection of the shaft frame
43 frame wall
44 frame base
45 sealing means
50 manhole covering
I unlocking position, unlocking state
II locking position, locking state
III pressing position, pressing state

What is claimed is:

1. A manhole cover (10) for a manhole covering (50) comprising
at least one locking device (20) for locking the manhole cover (10) to a shaft frame (40) of the manhole covering (50), wherein the locking device (20) has a latch (21) which is movable between an unlocking position (I) and a locking position (II), and
a monitoring device (30) for monitoring the locking,
wherein
the latch (21) is movable from the locking position (II) into a pressing position (III) in order to press the manhole cover (10) firmly against the shaft frame (40) during use, wherein the monitoring device (30) is designed to detect the unlocking position (I), the locking position (II), and the pressing position (III) of the latch (21).

2. The manhole cover (10) according to claim 1,
wherein
the locking device (20) has at least one screw (22) actuatable from an outer side (11) of the manhole cover (10), which in use moves the latch (21) between the locking position (II) and the pressing position (III).

3. The manhole cover (10) according to claim 2,
wherein
the screw (22) is adapted to move the latch (21) between the unlocking position (I) and the locking position (II).

4. The manhole cover (10) according to claim 1,
wherein
the locking device (20) has a stop in each case for the latch (21) in the unlocking position (I) and in the locking position (II).

5. The manhole cover (10) according to claim 1,
wherein
the manhole cover (10) has at least two locking devices (20).

6. The manhole cover (10) according to claim 5,
wherein
the locking devices (20) are arranged distributed in the circumferential direction of the manhole cover (10).

7. The manhole cover (10) according to claim 1,
wherein
the monitoring device (30) has at least one sensor (31) for detecting the position of the latch (21).

8. The manhole cover (10) according to claim 1,
wherein
the monitoring device (30) has an antenna (32) in order to transmit the information about the position of the latch (21) wirelessly to a monitoring center.

9. The manhole cover (10) according to claim 1,
wherein
the monitoring device (30) has at least one energy storage device (33) for autonomous energy supply.

10. The manhole cover (10) according to claim 1,
wherein
the monitoring device (30) is arranged in a protected housing (34) on an inner side (12) of the manhole cover (10).

11. A manhole covering (50) having a manhole cover (10) according to claim 1 and a shaft frame (40) for receiving the manhole cover (10), wherein the manhole cover (10) rests on a support surface (41) of the shaft frame (40).

12. The manhole covering (50) according to claim 11,
wherein
the latch (21) of the locking device (20) in the locking position (II) engages behind the shaft frame (40) and in the pressing position (III) presses against the shaft frame (40) so that the manhole cover (10) is pressed firmly against the support surface (41) of the shaft frame (40).

13. A monitoring system having at least one manhole covering (50) according to claim 11 and a monitoring center, wherein the monitoring center is designed to receive the information about the position of the latch (21) from the monitoring device (30) and to visualize the position of the latch (21).
